(19) United States
(12) Patent Application Publication
(10) Pub. No.: US 2007/0141361 A1
(43) Pub. Date: Jun. 21, 2007

(54) Polymer comprising 3-(n-silylalkyl) aminopropenoate groups and use thereof

(75) Inventors: Urs Burckhardt, Zurich (CH); Pierre-Andre Butikofer, Wallisellen (CH)

Correspondence Address: OLIFF & BERRIDGE, PLC, P.O. BOX 19928, ALEXANDRIA, VA, 22320, US

(73) Assignee: Sika Technology AG, Baar (CH)

(21) Appl. No.: 10/539,345

(22) PCT Filed: Dec. 18, 2003
(86) PCT No.: PCT/EP03/14570

§ 371 Date: Nov. 27, 2006

(30) Foreign Application Priority Data
Dec. 19, 2002 (EP) 02028481.6

(51) Int. Cl. B32B 27/00; C08G 77/00; C08L 83/00

(52) U.S. Cl. 428/447; 528/26; 528/28; 528/29

(57) ABSTRACT

The invention relates to a moisture-curing single-component composition which comprises at least one polymer that contains 3-(N-silylalkyl)-amino-propenoate groups and is described by formula (I). The inventive composition is useful as an adhesive, sealant, coating, or lining. Said polymer of formula (I) is characterized by a low viscosity, has a long shelf life in a moisture-free environment, and hardens when entering in contact with moisture so as to form a cross-linked polymer having elastic properties.

### FIELD OF THE INVENTION

The invention relates to the area of one-component moisture-curing compositions which are used in particular as adhesives, sealing compounds, coatings or linings. These compositions comprise at least one polymer comprising 3-(N-silylalkyl)aminopropenoate groups, have a long shelf life in the absence of moisture and harden on contact with moisture to give a crosslinked material having elastic properties.

### DESCRIPTION OF THE PRIOR ART

One-component, moisture-curing compositions having elastic properties are known. They are used, for example, for the sealing of joints and for the adhesive bonding of components. Compared with two-component systems, one-component systems have the advantage that no mixing process is necessary prior to application, with the result that firstly less work is required and secondly sources of error, such as, for example, an incorrect dose of the components or inhomogeneous mixing, are absent. Conventional one-component adhesives, sealing compounds and coatings having elastic properties usually comprise polyurethane polymers containing isocyanate groups and prepared from polyols and polyisocyanates which harden during application by reaction with water. Owing to the toxicity of the isocyanates, however, the market is increasingly demanding toxicologically safer isocyanate-free alternatives.

Polymers which comprise silane groups are an alternative to said isocyanate-containing systems. The term “silanes” or “silane groups” is understood in particular and in the entire document as meaning organoalkoxysilanes, i.e. special organosilicon compounds in which at least one alkoxy group is bonded to the silicon atom, usually two or three alkoxy groups are bonded to the silicon atom. These silanes have the property of hydrolyzing on contact with moisture. This results in the formation of organosilanols (organosilicon compounds comprising one or more silanol groups, Si—OH groups) and, by subsequent condensation reactions, organosiloxanes (organosilicon compounds comprising one or more siloxane groups, Si—O—Si groups). With polymers containing silane groups, it is possible to obtain isocyanate-free one-component compositions which harden as a result of contact with moisture and can be used, for example, as an adhesive, sealing compound, coating or lining.

One possibility for the preparation of polymers containing silane groups consists in reacting the isocyanate groups of a polyurethane polymer with organosilanes reactive toward isocyanates, such as, for example, aminoalkylsilanes, described, for example, in U.S. Pat. No. 3,632,557. However, such systems have some disadvantages. Firstly, isocyanates are still used in the preparation process in that isocyanate-containing polymers are first synthesized; this is unsatisfactory from the toxicological point of view. Secondly, polymers containing silane groups and prepared by this method have a relatively high viscosity which complicates the handling thereof and the preparation of compositions having good application properties.

Another possibility for the preparation of polymers containing silane groups is described, for example, in U.S. Pat. No. 4,345,053 and U.S. Pat. No. 5,990,257. There, polymers which comprise active hydrogen atoms, for example in the form of OH groups, are reacted with isocyanatoalkylsilanes. In this way, polymers containing silane groups and having a low viscosity are obtained. The required isocyanatoalkylsilanes are, however, difficult to prepare and therefore expensive. Moreover, they are toxicologically unsafe.

A further possibility for the preparation of polymers containing silane groups which manages completely without the use of isocyanates is the technology of the silane-terminated polyethers known on the market as MS polymers, described, for example, in U.S. Pat. No. 3,971,751. There, polymers having terminal double bonds, usually allyl-terminated polyoxyalkylene polymers, are subjected to a hydrosilylation reaction with alkoxysilanes, polymers containing silane groups and having a particularly low viscosity forming, which polymers are likewise suitable for use in one-component moisture-curing compositions. However, as a result of their preparation, the MS polymers have disadvantages. Firstly, the hydrosilylation reaction can be carried out on an industrial scale only with special equipment; secondly, the platinum catalysts usually used therein are expensive. The conversion of the hydrosilylation reaction is often incomplete, i.e. some of the allyl groups do not react and remain in the polymer, with the result that its content of silane groups is often substantially lower than desired, which may lead to sacrifices in the properties of the hardened polymer. Furthermore, the allyl-terminated polymers used for the hydrosilylation reactions are not permitted to comprise any impurities which would interfere with the hydrosilylation catalyst. Moreover, the very toxic allyl chloride is usually used for the preparation of the allyl-terminated polymers.

There is therefore a need for a polymer which contains silane groups and can be prepared by simple means and without the use of toxicologically unsafe substances, has a long shelf life in the absence of moisture, has a low viscosity and hardens on contact with moisture to give a crosslinked polymer having elastic properties. The use of 3-oxopropanoate groups for functionalizing polymers is widely described in the literature. In general, polymers containing such 3-oxopropanoate groups are reacted with polyamines to give amino-functional polymers.

The reaction of polymers comprising 3-oxopropanoate groups with aminoalkylsilanes is likewise known, but as a two-component system in which the aminoalkylsilanes are stored separately from the polymers comprising 3-oxopropanoate groups and come into contact with these only during the application of the system. U.S. Pat. No. 5,242,978 describes such a two-component system.

The reaction of polymers comprising 3-oxopropanoate groups with aminoalkylsilanes in the aqueous phase is likewise known. U.S. Pat. No. 5,426,142 describes allegedly self-crosslinking polymers which are dispersed in water and prepared from polymers which contain acetoacetate groups and to which aminoalkylsilanes have been partly or completely added in the aqueous phase. The polymers containing acetoacetate groups are preferably prepared by polymerizing a monomer mixture which comprises both vinyl-functional monomers and those having a vinyl and an acetoacetate function. During the addition of the aminoalkylsilane to the dispersed polymer having free acetoacetate groups, a special wetting agent is preferably present. However, such systems based on aqueous dispersions have serious disadvantages in comparison with the nonaqueous moisture-curing systems sought for the purposes of this invention. Aqueous dispersion systems are known to be subject to considerable shrinkage and usually have substantially poorer adhesion properties and higher sensitivity to water contact in the hardened state than nonaqueous, moisture-curing systems.

U.S. Pat. No. 6,121,404 describes the preparation of β-diketo-functional organosilanes and organosiloxanes. For this purpose, silanes or polysiloxanes comprising hydroxyalkyl or aminoalkyl groups are reacted with a suitable acetoacetylating reagent, such as, for example, diketene. The products obtained can be used as a basis for hardenable compositions or can be used as additives for other polymers. Also mentioned is a method for reacting a β-diketoalkyl-functional polysiloxane with an aminoalkyl-functional polysiloxane in order to obtain a hardened product. A polymer which contains silane groups and would be suitable for use in one-component moisture-curing compositions is not described in this patent.

A moisture-curing one-component composition comprising a polymer which contains silane groups and has a long shelf life and in which the silane groups are bonded in the form of 3-(N-silylalkyl)aminopropenoate groups to the polymer chain has not been described to date.

### SUMMARY OF THE INVENTION

It was an object of the present invention to provide a moisture-curing one-component composition based on a polymer which contains silane groups, can be prepared by simple means and without the use of toxicologically unsafe substances and has a long shelf life in the absence of moisture, has a low viscosity, hardens on contact with moisture to give a crosslinked material having elastic properties and is not water-based.

Surprisingly, it has now been found that the object can be achieved by a composition as claimed in claim 1, comprising at least one polymer having 3-(N-silylalkyl)aminopropenoate groups. The polymer described has a low viscosity, has a long shelf life in the absence of moisture and hardens on contact with moisture to give a crosslinked polymer having elastic properties.

There are various possibilities for the preparation of the polymer described. A preferred preparation method by means of which a polymer comprising 3-(N-silylalkyl)aminopropenoate groups is obtainable by means of economical raw materials and without expensive synthesis steps starts from a polymer comprising 3-oxopropanoate groups, which is reacted with aminoalkylsilanes. Not obvious to the person skilled in the art is the fact that a polymer containing silane groups and prepared by this method has a low viscosity and has a long shelf life in the absence of moisture. When a polymer comprising 3-oxopropanoate groups is reacted with aminoalkylsilanes, one mole of water is in fact formed per mole of reacted 3-oxopropanoate groups, which is problematic in that the silane groups present could be undesirably hydrolyzed thereby, which would inevitably lead to premature crosslinking of the polymer and hence to considerable increase in viscosity and the loss of storage stability through the secondary reactions (condensation) described above. In the context of this invention, it has, however, surprisingly been found that the reaction can be carried out without premature hydrolysis and condensation of the silane groups occurring. This can be achieved by removing the water formed in the reaction from the reaction mixture in a suitable manner. As a result, a polymer which contains silane groups and has a long shelf life in the absence of moisture is obtained.

The polymer described can therefore be prepared without using isocyanates and from economical raw materials which are not very toxic. It is suitable as a basis for one-component moisture-curing compositions having a long shelf life, good application properties, rapid curing and elastic properties in the hardened state.

### DESCRIPTION OF THE PREFERRED EMBODIMENTS

The present invention relates to a moisture-curing one-component composition comprising at least one polymer having 3-(N-silylalkyl)aminopropenoate groups, described by the formula (I) 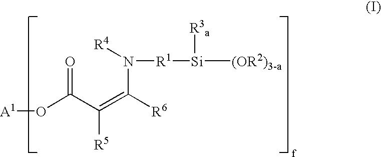
in which A¹ is formally the radical of an optionally chain-extended, polymeric alcohol after removal of f OH groups;
f is the average functionality, based on the 3-(N-silylalkyl)aminopropenoate groups and f is in the range between 1 and 3, preferably in the range between 1.2 and 2.5;
R¹ is a linear or branched, optionally cyclic, alkylene group having 1 to 20 carbon atoms, optionally having aromatic moieties, and optionally having one or more hetero atoms, in particular nitrogen atoms;
R² is an alkyl group having 1 to 5 carbon atoms, preferably a methyl group or an ethyl group or an isopropyl group, in particular a methyl group or an ethyl group;
R³ is an alkyl group having 1 to 8 carbon atoms, preferably a methyl or an ethyl group, in particular a methyl group;
a is 0, 1 or 2;
R⁴ is a hydrogen atom or an optionally substituted alkyl, aryl or arylalkyl group;
R⁵ and R⁶, independently of one another, are a hydrogen atom or an optionally substituted alkyl, aryl or arylalkyl group, or R⁵ and R⁶ together are an optionally substituted alkylene group and thus form a cyclic compound.

Preferably, R¹ is a methylene, propylene, methylpropylene, butylene or dimethylbutylene group, in particular a propylene group.

Furthermore, R⁴ is preferably a hydrogen atom.

Furthermore, R⁵ is preferably a hydrogen atom and R⁶ is a methyl group.

Throughout the document, the term “polymer” denotes firstly a group of macromolecules which are chemically uniform but differ with respect to the degree of polymerization, molar mass and chain length, which group was prepared by a polyreaction (polymerization, polyaddition, polycondensation). Secondly, the term “polymer” in this document also includes derivatives of such a group of macromolecules from polyreactions, i.e. compounds which were obtained by reactions, such as, for example, additions or substitutions, of functional groups on specified macromolecules and which may be chemically uniform or chemically nonuniform.

A “polymeric alcohol” is understood as meaning a polymer according to the above description which has one or more hydroxyl groups per molecule.

The number of a functional group in a molecule is referred to throughout the document as “functionality”.

Throughout the document, the “average functionality” denotes the arithmetic mean (number average) of the number of functional groups in a polymer, i.e. the sum of the product of the respective functionality of the individual macromolecules present in the polymer and their molar proportions.

Throughout the document, a “moisture-curing composition” is understood as meaning a nonaqueous mixture, i.e. a mixture which contains no water or at most traces of water; it thus differs fundamentally from an aqueous system, such as, for example, an aqueous dispersion. On application, the moisture-curing composition or the polymer comes into contact with moisture, whereupon curing takes place through chemical reaction with water. The water required for this curing reaction originates either from the air (atmospheric humidity) or from an added component which in turn comprises water.

The polymer of the formula (I) having 3-(N-silylalkyl)aminopropenoate groups, which is a component of the composition according to the invention, is distinguished by the fact that it has a long shelf life in the absence of moisture, has low viscosity and hardens on contact with moisture to give a crosslinked polymer having elastic properties. Throughout the document, “having a long shelf life” denotes a polymer which, when stored in the absence of moisture in suitable packaging, does not change substantially either in its performance characteristics or in its properties, after curing, over a period of from several months to one year or longer. Such a polymer therefore does not change on storage either, for example, in its viscosity or in its reactivity or in its mechanical behavior in the hardened state to an extent relevant for its use.

There are various conceivable methods for the preparation of a polymer of the formula (I) comprising 3-(N-silylalkyl)aminopropenoate groups. A preferred preparation method by which a polymer of the formula (I) is obtainable by means of economical raw materials and without expensive synthesis steps starts from a polymer of the formula (II) comprising 3-oxopropanoate groups, which is reacted with aminoalkylsilanes of the formula (III) under suitable conditions, as shown in the following equation:

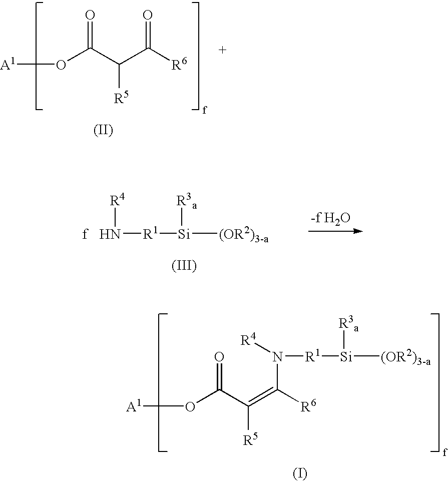

The reaction of polymers comprising 3-oxopropanoate groups with diamines is described, for example, by G. Grogler and G. Oertel in U.S. Pat. No. 3,666,726. If, however, amines containing silane groups, such as the aminoalkylsilanes of the formula (III), are used in this reaction instead of diamines, the problem arises that the water forming during the reaction can react with the—hydrolyzable—silane groups. However, it is essential to avoid this since the hydrolysis of the silane and the secondary reactions described below—in the description of the application and curing of the polymer according to the invention—would lead to premature crosslinking of the polymer of the formula (I), associated with a considerable increase in viscosity and the loss of the storage stability. Use of the polymer of the formula (I) as a binder for one-component compositions without removal in a suitable manner of the water formed during the preparation would then no longer be possible.

The following method has proven to be suitable for the reaction of compounds comprising 3-oxopropanoate groups with aminoalkylsilanes: the polymer of the formula (II) is reacted with the aminoalkylsilane of the formula (III) in the stoichiometric ratio or with a stoichiometric excess of aminoalkylsilane at temperatures of from 20° C. to 150° C., preferably without the use of solvents, the water forming being removed directly from the reaction mixture during the entire duration of reaction by applying a vacuum. Catalysts can optionally be concomitantly used, for example acids, such as, for example, alkylbenzenesulfonic acids, alkylsulfonic acids, trifluoroacetic acid, acidic phosphoric esters, mineral acids, boron trifluoride complexes or aluminum chloride complexes. In this way, a polymer of the formula (I) comprising 3-(N-silylalkyl)aminopropenoate groups is obtained, which polymer has a long shelf life in the absence of moisture and has a viscosity which is only insignificantly higher than that of the polymer of the formula (II).

The following may be mentioned by way of example as suitable aminoalkylsilanes of the formula (III): 3-aminopropyltriethoxysilane, 3-aminopropyldiethoxy-methylsilane, 3-amino-2-methylpropyltriethoxysilane, 4-aminobutyltriethoxysilane, 4-aminobutyldiethoxymethylsilane, 4-amino-3-methylbutyltriethoxysilane, 4-amino-3,3-dimethylbutyltriethoxysilane, 4-amino-3,3-dimethylbutyldiethoxymethylsilane, 2-aminoethyltriethoxysilane, 2-aminoethyldiethoxymethylsilane, aminomethyltriethoxysilane, aminomethyldiethoxymethylsilane, aminomethylmethoxydimethylsilane, aminomethylethoxydimethylsilane, N-(2-aminoethyl)-3-aminopropyltriethoxysilane, N-(2-aminoethyl)-3-aminopropyldiethoxymethylsilane, 7-amino-4-oxaheptyldiethoxymethylsilane, N-methyl-3-aminopropyltriethoxysilane, N-(n-butyl)-3-aminopropyltriethoxysilane, N-(n-butyl)aminomethyltriethoxysilane and the analogs thereof with methoxy or isopropoxy groups instead of the ethoxy groups, and further aminoalkylsilanes and any desired mixtures of such aminoalkylsilanes.

A polymer of the formula (II) comprising 3-oxopropanoate groups can be prepared starting from polymeric alcohols. There are various possibilities for converting a hydroxyl group into a 3-oxopropanoate group. Some of these are described in “Acetic Acid and its Derivatives”, V. H. Agreda, J. R. Zoeller (Eds.), Marcel Dekker Inc., New York 1993, Chapter 11. For example, diketene (IV) or dioxinones, such as, for example, the diketene-acetone adduct (V) (=2,6,6-trimethyl-4H-1,3-dioxin-4-one), may be used as reagents for the functionalization of hydroxyl groups to acetoacetate groups. A transesterification (transacetoacetylation) starting from acetoacetates is also possible, sterically hindered esters, such as tert-butyl acetoacetate (VI), owing to their substantially higher reaction rate, being preferable to other esters, such as, for example, methyl or ethyl acetoacetate.

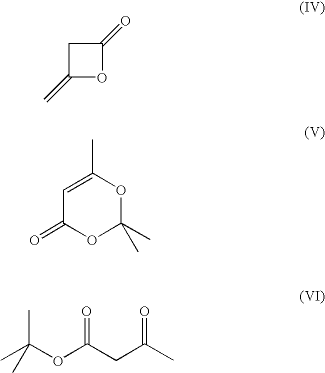

For the preparation of a polymer of the formula (II) comprising 3-oxoapropanoate groups, compounds of the formula (VII) are particularly suitable, R⁵ and R⁶ having the abovementioned meaning and R⁷ being a linear or branched alkyl group having 1 to 6 carbon atoms, preferably a tert-butyl group.

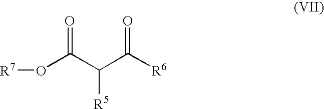

Such a transesterification can be carried out in the stoichiometric ratio at temperatures of from 20° C. to 150° C., preferably without the use of solvents. Catalysts, such as, for example, the above-mentioned acids, are preferably concomitantly used. During the transesterification, the alcohol R⁷—OH is continuously removed by means of distillation, optionally under reduced pressure. The conversion, i.e. the completeness of the transesterification reaction, may be less than 100%, depending on reaction conditions and starting materials used. Particularly in the reaction of polymeric alcohols having very high molecular weights, the conversion may be lower.

If the polymer of the formula (II) has a hydrogen atom as R⁵, the 3-oxopropanoate group may be slightly alkylated in the 2-position (i.e. at the methylene group), as described in the abovementioned book “Acetic Acid and its Derivatives”, on page 193/194. In this way, is it possible to introduce a group R⁵ in the form of an optionally substituted alkyl, aryl or arylalkyl group. A compound of the formula (VII) where R⁵═H can likewise be alkylated in the 2-position before the transesterification is carried out.

For example, the following polyols or any desired mixtures thereof can be used as polymeric alcohols for the preparation of a polymer of the formula (II) comprising 3-oxopropanoate groups:

polyoxyalkylenepolyols, also referred to as polyetherpolyols, which are polymerization products of ethylene oxide, 1,2-propylene oxide, 1,2- or 2,3-butylene oxide, tetrahydrofuran or mixtures thereof, possibly polymerized with the aid of an initiator molecule having two or more active hydrogen atoms, such as, for example, water, ammonia or compounds having a plurality of OH or NH groups, such as, for example, 1,2-ethanediol, 1,2- and 1,3-propanediol, neopentylglycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline and mixtures of the above-mentioned compounds. Both polyoxyalkylenepolyols which have a low degree of unsaturation (measured according to ASTM D-2849-69 and stated in milliequivalent of unsaturation per gram of polyol (meq/g)), prepared, for example, with the aid of so-called double metal cyanide complex catalysts (DMC catalysts), and polyoxyalkylenepolyols having a higher degree of unsaturation, prepared, for example, with the aid of anionic catalysts, such as NaOH, KOH or alkali metal alcoholates, may be used.

Particularly suitable are polyoxyalkylenediols or polyoxyalkylenetriols, in particular polyoxypropylenediols or polyoxypropylenetriols.

Specially suitable are polyoxyalkylenediols or polyoxyalkylenetriols having a degree of unsaturation of less than 0.02 meq/g and having a molecular weight in the range from 1000 to 30 000 g/mol.

Also particularly suitable are so-called “EO-endcapped” (ethylene oxide-endcapped) polyoxypropylenediols or triols. The latter are in particular polyoxypropylenepolyoxyethylenepolyols, which are obtained, for example, by alkoxylating pure polyoxypropylenepolyols with ethylene oxide after completion of the polypropoxylation and therefore have primary hydroxyl groups. Here and below, “molecular weight” is always understood as meaning the weight average molecular weight Mₙ.

hydroxy-functional polybutadienes,

polyesterpolyols, prepared, for example, from dihydric or trihydric alcohols, such as, for example, 1,2-ethanediol, diethylene glycol, 1,2-propanediol, dipropylene glycol, 1,4-butanediol, 1,5-pentanediol, 1,6-hexanediol, neopentylglycol, glycerol, 1,1,1-trimethylolpropane and mixtures of the above-mentioned alcohols, with organic dicarboxylic acids or anhydrides or esters thereof, such as, for example, succinic acid, glutaric acid, adipic acid, suberic acid, sebacic acid, dodecanedicarboxylic acid, maleic acid, fumaric acid, phthalic acid, isophthalic acid, terephthalic acid and hexahydrophthalic acid or mixtures of the abovementioned acids, and polyesterpolyols obtained from lactones, such as, for example, ε-caprolactone;

polycarbonatepolyols, as obtainable by reacting, for example, the abovementioned alcohols—used for the synthesis of the polyesterpolyols—with dialkyl carbonates, diaryl carbonates or phosgene;

polyacrylatepolyols and polymethacrylatepolyols.

Furthermore, said polyhydric polymeric alcohols or polyols may be chain-extended. Chain extension can be effected by various methods. For example, the polymeric alcohol can be reacted with less than the stoichiometric amount of diisocyanates to give a hydroxy-functional polyurethane; in the context of the present invention, however, this method is not preferred because it requires the use of isocyanate-containing compounds.

In a further, preferred method, chain extension of A¹ is formally achieved by first derivatizing a diol from the group consisting of the abovementioned polymeric alcohols to give a polymer of the formula (II) comprising 3-oxopropanoate groups and then reacting this in an additional step with less than the stoichiometric amount of diamines. As a result of this process, a polymer of the formula (II) comprising 3-oxopropanoate groups is once again obtained, which polymer can then be reacted with an aminoalkylsilane of the formula (III) to give a polymer of the formula (I) comprising 3-(N-silylalkyl)aminopropenoate groups. In this case, the group denoted by A¹ in formula (I) formally denotes the radical of a polymeric diol after removal of both OH groups, which diol comprises 3-aminopropenoate groups in the chain. In this method of chain extension, the amino groups of the diamine react with the 3-oxopropanoate groups of the polymer of the formula (II) by known, abovementioned methods. This gives rise to structures which are illustrated by the following schematic representation for the example of a primary diamine:

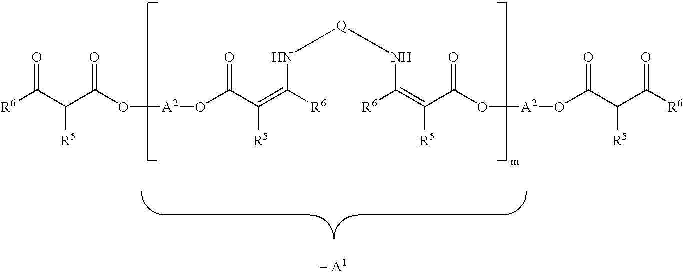

In this schematic representation, A² is the radical of a polymeric diol after removal of both OH groups,

Q is the radical of a diamine after removal of both amino groups,

m is an integer greater than 0, and

A¹, R⁵ and R⁶ have the abovementioned meaning.

The described method for the preparation of a polymer of the formula (I) is only one possibility. In addition to the reaction of a polymer of the formula (II) comprising 3-oxopropanoate groups with an aminoalkylsilane of the formula (III), other possibilities are also conceivable.

For example, an aminoalkylsilane of the formula (III) can first be reacted with, for example, tert-butyl acetoacetate to give an alkylsilane comprising a tert-butyl[3-(N-silylalkyl)amino]propenoate group. It is possible thereby to adopt the same procedure as in the above-described reaction of a polymer of the formula (II) with an aminoalkylsilane of the formula (III). The alkylsilane thus obtained and comprising a tert-butyl[3-(N-silylalkyl)amino]propenoate group can then be transesterified with a polymeric alcohol to give a polymer of the formula (I).

A further possibility for the preparation of a polymer of the formula (I) consists in first transesterifying a carboxylic ester diunsaturated in the 1,2-position with a polymeric alcohol to give a polymer of the formula (VIII) and then subjecting an aminoalkylsilane of the formula (III) to an addition reaction at the triple bond (Michael addition). Such an addition is mentioned, for example, in “Organikum”, 20th Edition, 1996, on page 303. 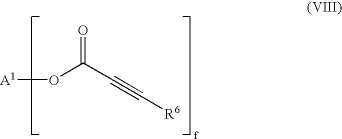
A¹, R⁶ and f in the formula (VIII) have the meaning already described.

Further components, which however must not adversely affect the shelf life of the silane groups, can be added to the described composition comprising at least one polymer of the formula (I) having 3-(N-silylalkyl)aminopropenoate groups. This essentially means that such added components may contain no water or at most traces of water. Inter alia, the following well known auxiliaries and additives may be present as additional components:

plasticizers, for example esters of organic carboxylic acids or anhydrides thereof, phthalates, such as, for example, dioctyl phthalate or diisodecyl phthalate, adipates, such as, for example, dioctyl adipate, sebacates, polyols, such as, for example, polyoxyalkylenepolyols or polyesterpolyols, organic phosphoric and sulfonic esters or polybutenes; solvents; inorganic and organic fillers, such as, for example, ground or precipitated calcium carbonates, which are optionally coated with stearates, in particular finely divided coated calcium carbonate, carbon blacks, kaolins, aluminas, silicas, PVC powder or hollow balls; fibers, for example comprising polyethylene; pigments; catalysts, such as, for example, organotin compounds, such as dibutyltin dilaurate, dibutyltin diacetylacetonate, organobismuth compounds or bismuth complexes, or compounds containing amino groups, such as, for example, 1,4-diazabicyclo[2.2.2]octane, 2,2′-dimorpholinodiethyl ether or aminoalkylsilanes; rheology modifiers, such as, for example, thickeners, for example urea compounds, polyamide waxes, bentonites and pyrogenic silicas; adhesion promoters, such as, for example, mercaptoalkylsilanes, methacryloyloxyalkylsilanes, isocyanatoalkylsilanes, vinylsilanes, epoxyalkylsilanes or aminoalkylsilanes, in particular 3-aminopropyltrimethoxysilane, 3-aminopropyltriethoxysilane, N-(2-aminoethyl)-3-aminopropyltrimethoxysilane or bis(3-(trimethoxysilyl)propyl)amine, and oligomeric forms of these silanes; crosslinking agents, such as, for example, silane-functional oligo- and polymers and low molecular weight compounds comprising 3-(N-silylalkyl)aminopropenoate groups, for example prepared as described below; drying agent, such as, for example, vinyltrimethoxysilane or orthoformic esters, calcium oxide or molecular sieves; heat stabilizers, light stabilizers and UV stabilizers; flame-retardant substances; surface-active substances, such as, for example, wetting agents, leveling agents, deaerators or antifoams; fungicides or substances inhibiting fungal growth; and further substances usually used.

Those low molecular weight compounds comprising 3-(N-silylalkyl)aminopropenoate groups which are mentioned can be prepared, for example, by reacting low molecular weight, i.e. nonpolymeric, alcohols having one, two or more hydroxyl groups first to give compounds comprising 3-oxopropanoate groups and then to give low molecular weight compounds comprising 3-(N-silylalkyl)aminopropenoate groups. This reaction can be effected in the same way as described above for the polymeric alcohols. If desired, such low molecular weight alcohols can also be reacted as a mixture with said polymeric alcohols.

Suitable low molecular weight alcohols are, for example, methanol, ethanol, the isomeric propanols, butanols, pentanols, hexanols, higher fatty alcohols and wax alcohols, benzyl alcohol, hydroxymethylcyclohexane, 2-cyclohexylethanol; unsaturated alcohols, such as, for example, oleyl alcohol, (+/−)-beta-citronellol, cinnamic alcohol, propargyl alcohol, allyl alcohol, 3-methyl-3-buten-1-ol, crotyl alcohols; alcohols having additional functional groups, such as, for example, 3-methoxy-3-methyl-1-butanol, 3-hydroxypropionitrile, 2-(2-hydroxyethyl)pyridine, 1-(2-hydroxyethyl)-2-pyrrolidone, 2-hydroxyethyl methyl sulfide, 2-hydroxyethyl methyl sulfone, 2,2,2-trifluoroethanol, 2-methoxyethanol, 2-isopropoxyethanol, 2-furfuryloxyethanol or 2-phenoxyethanol; cycloaliphatic alcohols, such as, for example, cyclohexanol, furfuryl alcohol, tetrahydrofurfuryl alcohol; low molecular weight reaction products of alcohols with ethylene oxide or 1,2-propylene oxide, so-called alcohol-initiated ethoxylates and propoxylates, such as, for example, diethylene glycol monostearyl ether, dipropylene glycol monomethyl ether; dihydric alcohols or alcohols having a higher OH functionality, such as, for example, 1,2-ethanediol, 1,2- and 1,3-propanediol, neopentylglycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, 1,1,1-trimethylolethane, 1,1,1-trimethylolpropane, pentaerythritol, dimeric fatty alcohols, glycerol, sugar alcohols; low molecular weight alkoxylation products of the above-mentioned dihydric alcohols and alcohols having a higher OH functionality; and mixtures of the abovementioned low molecular weight alcohols.

Furthermore, the described composition comprising at least one polymer of the formula (I) having 3-(N-silylalkyl)aminopropenoate groups may also comprise other polymers which have hydrolyzable silane groups. The following may be mentioned by way of example for such polymers containing silane groups: reaction products of polyurethane polymers containing isocyanate groups with organosilanes reactive toward isocyanates, such as, for example, mercaptoalkylsilanes or aminoalkylsilanes, described, for example, in U.S. Pat. No. 3,632,557, in particular the reaction products of polyurethane polymers containing isocyanate groups with Michael adducts of aminoalkylsilanes and maleic or fumaric diesters, described, for example, in EP 0 403 921; products from hydrosilylation reactions of polymers having terminal double bonds, in particular of allyl-terminated polyoxyalkylene polymers, with alkoxysilanes, described, for example, in U.S. Pat. No. 3,971,751 and U.S. Pat. No. 6,207,766; reaction products of polymers comprising active hydrogen atoms, for example in the form of hydroxyl or mercapto groups, with isocyanatoalkylsilanes, described, for example, in U.S. Pat. No. 4,345,053 and U.S. Pat. No. 5,990,257.

The described composition comprising at least one polymer of the formula (I) is stored in the absence of moisture. It has a long shelf life, i.e. it can be stored in the absence of moisture in a suitable packaging or arrangement, such as, for example, a drum, a bag or a cartridge, over a period of from several months to one year without changing in its performance characteristics or in its properties after curing to an extent relevant for its use.

On application of the described composition comprising at least one polymer of the formula (I), the surface of at least one arbitrary solid or article is brought into contact, at least partially, with the composition. Uniform contact in the form of an adhesive or sealing compound, of a coating or of a lining is preferred. It is quite possible that it will then be necessary for the solid or article to be brought into contact to be subjected, prior to bringing into contact, to a physical and/or chemical pretreatment, for example by grinding, sand blasting, brushing or the like, or by treatment with cleaning agents, solvents, adhesion promoters, adhesion promoter solutions or primers, or to the application of an adhesive-bonded joint or of a sealer.

During the application of the described composition comprising at least one polymer of the formula (I) to at least one solid or article, the polymer of the formula (I) comes into contact with moisture. The silane groups have the properties of hydrolyzing on contact with moisture. This results in the formation of organosilanols (organosilicon compounds comprising one or more silanol groups, such as Si—OH groups) and, by subsequent condensation reactions, organosiloxanes (organosilicon compounds comprising one or more siloxane groups, Si—O—Si groups), with the result that the composition finally hardens to give a resilient material. The water required for the curing reaction either may originate from the air (atmospheric humidity) or the composition can be brought into contact with a water-comprising component, for example by spreading, for example by a smoothing means, or by spraying, or a water-comprising component, for example in the form of a water-containing paste, which is mixed in, for example, by means of a static mixer, can be added to the composition during the application.

The described composition comprising a polymer of the formula (I) has, in the hardened state, both elastic properties and high stability to hydrolysis. This is surprising for the person skilled in the art since the 3-aminopropenoate group is potentially sensitive to hydrolysis. The elastic properties can be varied and thus adapted to the needs of the respective application by the starting materials used, such as the alcohols, the reagents for introducing the 3-oxopropanoate groups and the aminoalkylsilanes and by any additional components, as already mentioned.

The polymer of the formula (I) is suitable, for example, as a resilient one-component binder for adhesives, sealing compounds, coatings or as a lining for various solids and articles, in particular as a binder for adhesives and sealing compounds. It is particularly suitable for applications in which isocyanate-free products are required.

### EXAMPLES

Starting Materials Used

Acclaim® polyol 12200 (Bayer): Linear polypropylene oxide polyol having a theoretical OH functionality of 2, an average molecular weight of about 12 000 g/mol, an OH number of 10.8 mg KOH/g and a degree of unsaturation of about 0.005 meq/g.

Acclaim® polyol 4200N (Bayer): Linear polypropylene oxide polyol having a theoretical OH functionality of 2, an average molecular weight of about 4000 g/mol, an OH number of 28.1 mg KOH/g and a degree of unsaturation of about 0.007 meq/g.

1,5-Diamino-2-methylpentane (MPMD; DuPont): MPMD content≧98.5%; amine content=17.11 mmol NH₂/g.

3-Aminopropyltriethoxysilane (Dynasylan® AMEO; Degussa).

3-Aminopropyldimethoxymethylsilane (Silquest® Y-11159 silane; Crompton).

Dibutyltin diacetylacetonate (Metatin® K 740; Rohm and Haas).

Tinuvin® 292 (Ciba).

Description of the Test Methods

The viscosity was measured at 20° C. on a cone-and-plate viscometer from Haake (PK100/VT-500).

The skin formation time (tack-free time) was determined by applying the composition which is at room temperature in a layer thickness of 3 mm to cardboard at 23° C. and 50% relative humidity and then determining the time until the composition, when lightly touched on its surface by means of an LDPE pipette, no longer left any polymer residues on the pipette.

Tensile strength, elongation at break and modulus of elasticity at 0-25% elongation were determined according to DIN EN 53504 (traction rate: 200 mm/min).

Preparation of Polymers Comprising 3-oxopropanoate Groups

### Example 1

A mixture of 451.30 g of the polyol Acclaim® 12200, 13.70 g of tert-butyl acetoacetate and 0.083 g of methanesulfonic acid was heated to 120° C. under a nitrogen atmosphere and with vigorous stirring and was left at this temperature for 3 hours. Thereafter, the tert-butanol formed and unconverted tert-butyl acetoacetonate were distilled off in the course of one hour at 15 mbar and 120° C. The conversion of the polyol was 94% (determined by means of HPLC analysis).

### Example 2

A mixture of 451.30 g of the polyol Acclaim® 12200 and 13.70 g of tert-butyl acetoacetate was heated to 160° C. with vigorous stirring and left at this temperature for 3 hours, nitrogen being passed directly into the reaction mixture by means of a glass tube under reduced pressure (about 300 mbar). In this way, the tert-butanol formed and unconverted tert-butyl acetoacetate were removed from the reaction mixture. The conversion of the polyol was 65% (determined by means of HPLC analysis).

### Example 3

A mixture of 500.00 g of the polyol Acclaim® 12200, 30.27 g of pentaerythritol, 30.39 g of tert-butyl acetoacetate and 0.083 g of methanesulfonic acid was heated to 120° C. under a nitrogen atmosphere and with vigorous stirring and was left at this temperature for 3 hours. Thereafter, the tert-butanol formed and unconverted tert-butyl acetoacetonate were distilled off in the course of one hour at 15 mbar and 120° C.

### Example 4 (Additional Chain Extension)

A mixture of 500.00 g of the polyol Acclaim® 4200, 39.60 g of tert-butyl acetoacetate and 0.083 g of methanesulfonic acid was heated to 120° C. under a nitrogen atmosphere and with vigorous stirring and left at this temperature for 3 hours, and the tert-butanol formed and unconverted tert-butyl acetoacetate were then distilled off in the course of one hour at 15 mbar and 120° C. The mixture was cooled to 80° C. under atmospheric pressure, and 10.90 g of 1,5-diamino-2-methylpentane were added rapidly with thorough stirring. The mixture was left at 80° C. for 30 minutes, and the water formed during the reaction was then distilled off in the course of 45 minutes at 80° C. and 15 mbar.

Preparation of Polymers According to the Invention Comprising 3-(N-silylalkyl)aminopropenoate Groups

### Example 5

18.70 g of 3-aminopropyltriethoxysilane were added to 446.90 g of the polymer according to example 1 at 80° C. under a nitrogen atmosphere and with vigorous stirring, and the water formed was then distilled off in the course of 2 hours at 80° C. and 15 mbar. The reaction product had a viscosity of 9.2 Pa·s at 20° C.

### Example 6

14.14 g of 3-aminopropyldimethoxymethylsilane were added to 458.41 g of the polymer according to example 1 at 80° C. under a nitrogen atmosphere and with vigorous stirring, and the water formed was then distilled off in the course of 2 hours at 80° C. and 15 mbar. The reaction product had a viscosity of 11.6 Pa·s at 20° C.

### Example 7

18.40 g of 3-aminopropyltriethoxysilane were added to 440.00 g of the polymer according to example 2 at 80° C. under a nitrogen atmosphere and with vigorous stirring, and the water formed was then distilled off in the course of 2 hours at 80° C. and 15 mbar. The reaction product had a viscosity of 10.9 Pa·s at 20° C.

### Example 8

42.50 g of 3-aminopropyltriethoxysilane were added to 519.43 g of the polymer according to example 3 at 80° C. under a nitrogen atmosphere and with vigorous stirring, and the water formed was then distilled off in the course of 2 hours at 80° C. and 15 mbar. The reaction product had a viscosity of 11.5 Pa·s at 20° C.

### Example 9

13.50 g of 3-aminopropyltriethoxysilane were added to 517.50 g of the polymer according to example 4 at 80° C. under a nitrogen atmosphere and with vigorous stirring, and the water formed was then distilled off in the course of 2 hours at 80° C. and 15 mbar. The reaction product had a viscosity of 11.6 Pa·s at 20° C.

Preparation of Adhesives According to the Invention Composed of the Polymers According to the Invention Comprising 3-(N-silylalkyl)aminopropenoate Groups

### Example 10

0.1 part by weight of vinyltrimethoxysilane, 2 parts by weight of 3-aminopropyltriethoxysilane, 0.2 part by weight of dibutyltin diacetylacetonate, 0.3 part by weight of 2,6-di-tert-butyl-p-cresol and 0.3 part by weight of Tinuvin® 292 were added to 100 parts by weight of the polymer from example 5 and homogeneously mixed. The adhesive composition was immediately filled into air-tight tubes and these were stored for 15 hours at 60° C. Thereafter, a part of the mixture was poured into a PTFE-coated metal sheet (film thickness about 2 mm), hardened for 7 days at 23° C. and 50% relative humidity (=“standard conditions of temperature and humidity”) and the mechanical properties of the completely hardened film were then determined under standard conditions of temperature and humidity. For testing the stability to hydrolysis, the mechanical properties were additionally determined after storage of the test specimens for 7 days in demineralized water and after storage of the test specimens for 7 days at 70° C. and 100% relative humidity (r.h.). Before the determination of the mechanical values, the test specimens were each dried with a cloth and left for 2 hours under standard conditions of temperature and humidity.

With the remaining tube contents, the shelf life was determined by measuring the viscosity and the skin formation time before and after storage for 7 days at 60° C. The results of the tests are shown in table 1.

The results show that the adhesive composition of example 10 has a very good shelf life, a short skin formation time and good mechanical properties. The mechanical properties after storage of the hardened test specimens in water and at 70° C. and 100% relative humidity show that the adhesive composition has good stability to hydrolysis.

### Example 11

The same additives as described in example 10 were added in the same amount to 100 parts by weight of the polymer from example 6. The skin formation time and the mechanical properties of the completely hardened film were determined under standard conditions of temperature and humidity in the same manner as for example 10. The results of the tests are shown in table 2.

TABLE 1
Results of example 10.

| | Example |
|---|---|
| | 10 |
| Viscosity before storage (Pa · s) | 27 |
| Viscosity after storage (Pa · s) | 40 |
| Skin formation time before storage (min.) | 30 |
| Skin formation time after storage (min.) | 25 |
| Tensile strength after storage under standard | 0.5 |
| conditions of temperature and humidity (MPa) | |
| Elongation at break after storage under | 70 |
| standard conditions of temperature and | |
| humidity (%) | |
| Modulus of elasticity 0.5-5% after storage | 1.0 |
| under standard conditions of temperature and | |
| humidity (MPa) | |
| Tensile strength after storage in water (MPa) | 0.5 |
| Elongation at break after storage in water (%) | 80 |
| Modulus of elasticity 0.5-5% after storage in | 0.9 |
| water (MPa) | |
| Tensile strength after storage at 70° C./100% | 0.5 |
| r.h. (MPa) | |
| Elongation at break after storage at | 90 |
| 70° C./100% r.h. (%) | |
| Modulus of elasticity 0.5-5% after storage | 0.9 |
| at 70° C./100% r.h. (MPa) | |

### Example 12

The same additives as described in example 10 were added in the same amount to 100 parts by weight of the polymer from example 7. The skin formation time and the mechanical properties of the completely hardened film were determined under standard conditions of temperature and humidity in the same manner as for example 10. The results of the tests are shown in table 2.

### Example 13

The same additives as described in example 10 were added in the same amount to 100 parts by weight of the polymer from example 8, except that 0.6 part by weight of dibutyltin diacetylacetonate was used instead of 0.2 part by weight. The skin formation time and the mechanical properties of the completely hardened film were determined under standard conditions of temperature and humidity in the same way as for example 10. The results of the tests are shown in table 2.

### Example 14

The same additives as described in example 10 were added in the same amount to 100 parts by weight of the polymer from example 9, except that 1.0 part by weight of dibutyltin diacetylacetonate was used instead of 0.2 part by weight. The skin formation time and the mechanical properties of the completely hardened film were determined under standard conditions of temperature and humidity in the same way as for example 10. The results of the tests are shown in table 2.

TABLE 2
Results of examples 11-14.

| | Example | | | |
|---|---|---|---|---|
| | 11 | 12 | 13 | 14 |
| Skin formation time (min.) | 20 | 25 | 19 | 20 |
| Tensile strength after storage | 0.5 | 0.5 | 0.5 | 0.2 |
| under standard conditions of | | | | |
| temperature and humidity (MPa) | | | | |
| Elongation at break after storage | 190 | 120 | 40 | 190 |
| under standard conditions of | | | | |
| temperature and humidity (%) | | | | |
| Modulus of elasticity 0.5-5% after | 2.0 | 1.3 | 4.9 | 0.8 |
| storage under standard conditions | | | | |
| of temperature and humidity (MPa) | | | | |

The results in table 2 show that all adhesive compositions of examples 11 to 14 have a short skin formation time, harden to give a resilient material and have mechanical properties suitable for an adhesive.

1. A moisture-curing one-component composition comprising at least one polymer of the formula (I) 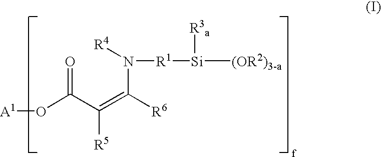
in which A¹ is the radical of an optionally chain-extended, polymeric alcohol after removal of f OH groups;
f is the average functionality based on the 3-(N-silylalkyl)aminopropenoate groups and f is in the range between 1 and 3;
R¹ is a linear or branched, optionally cyclic, alkylene group having 1 to 20 carbon atoms, optionally having aromatic moieties, and optionally having one or more hetero atoms, in particular nitrogen atoms;
R² is an alkyl group having 1 to 5 carbon atoms;
R³ is an alkyl group having 1 to 8 carbon atoms;
a is 0, 1 or 2;
R⁴ is a hydrogen atom or an optionally substituted alkyl, aryl or arylalkyl group;
R⁵ and R⁶, independently of one another, are a hydrogen atom or an optionally substituted alkyl, aryl or arylalkyl-group, or R⁵ and R⁶ together are an optionally substituted alkylene group and thus form a cyclic compound.

2. The moisture-curing one-component composition as claimed in claim 1, characterized in that f is in the range between 1.2 and 2.5.

3. The moisture-curing one-component composition as claimed in claim 1, characterized in that R¹ is a methylene, propylene, methylpropylene, butylene or dimethylbutylene group, in particular a propylene group.

4. The moisture-curing one-component composition as claimed in claim 1, characterized in that R² is a methyl group or an ethyl group or an isopropyl group, in particular a methyl group or an ethyl group.

5. The moisture-curing one-component composition as claimed in claim 1, characterized in that R³ is a methyl or an ethyl group, in particular a methyl group.

6. The moisture-curing one-component composition as claimed in claim 1, characterized in that R⁴ is a hydrogen atom.

7. The moisture-curing one-component composition as claimed in claim 1, characterized in that R⁵ is a hydrogen atom and R⁶ is a methyl group.

8. The moisture-curing one-component composition as claimed in claim 1, characterized in that the polymeric alcohol is a polyoxyalkylenepolyol, in particular a polyoxyalkylenediol or a polyoxyalkylenetriol, in particular a polyoxypropylenediol or polyoxypropylenetriol.

9. The moisture-curing one-component composition as claimed in claim 1, characterized in that the polymeric alcohol is a polyoxyalkylenediol or a polyoxyalkylenetriol having a degree of unsaturation of less than 0.02 meq/g and a molecular weight Mₙ of from 1000 to 30 000 g/mol.

10. The moisture-curing one-component composition as claimed in claim 1, characterized in that it additionally comprises at least one low molecular weight compound comprising 3-(N-silylalkyl)aminopropenoate groups.

11. The moisture-curing one-component composition as claimed in claim 1, characterized in that it additionally contains at least one polymer containing silane groups.

12. The moisture-curing one-component composition as claimed in claim 11, characterized in that the polymer containing silane groups is prepared by a hydrosilylation reaction from a polymer having terminal double bonds, in particular from allyl-terminated polyoxyalkylene polymers, with alkoxysilanes.

13. The moisture-curing one-component composition as claimed in claim 11, characterized in that the polymer containing silane groups is prepared from a polyurethane polymer containing isocyanate groups and organosilanes reactive toward isocyanates, in particular mercaptoalkylsilanes or aminoalkylsilanes, preferably Michael adducts of aminoalkylsilanes and maleic or fumaric diesters, or
from a polymer comprising active hydrogen atoms, for example in the form of hydroxyl or mercapto groups, and isocyanatoalkylsilanes.

14. The moisture-curing one-component composition as claimed in claim 1, characterized in that no isocyanate-containing compounds are used for their preparation.

15. A polymer of the formula (I) 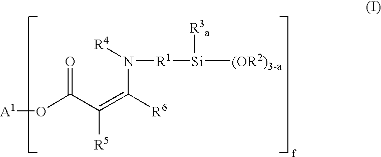
in which A¹ is the radical of an optionally chain-extended, polymeric alcohol after removal of f OH groups;
f is the average functionality based on the 3-(N-silylalkyl)aminopropenoate groups and f is in the range between 1 and 3, in particular between 1.2 and 2.5;
R¹ is a linear or branched, optionally cyclic, alkylene group having 1 to 20 carbon atoms, optionally having aromatic moieties, and optionally having one or more hetero atoms, in particular nitrogen atoms;
R² is an alkyl group having 1 to 5 carbon atoms;
R³ is an alkyl group having 1 to 8 carbon atoms;
a is 0, 1 or 2;
R⁴ is a hydrogen atom or an optionally substituted alkyl, aryl or arylalkyl group;
R⁵ and R⁶, independently of one another, are a hydrogen atom or an optionally substituted alkyl, aryl or arylalkyl group, or R⁵ and R⁶ together are an optionally substituted alkylene group and thus form a cyclic compound.

16. A process for the preparation of a polymer as claimed in claim 15 or of the composition as claimed in any of claims 1 to 14, comprising a step of the preparation of the polymer of the formula (I) from a polymer of the formula (II) which comprises 3-oxopropanoate groups and an aminoalkylsilane of the formula (III)

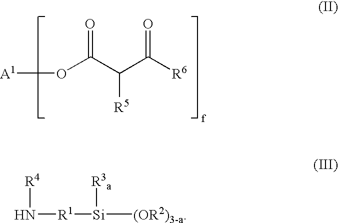

17. The process as claimed in claim 16, characterized in that the polymer of the formula (II) which comprises 3-oxopropanoate groups is prepared from a polymeric alcohol of the formula A¹(OH)_{f}
and a compound of the formula (VII) 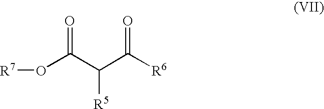
in which R⁷ is a linear or branched alkyl group having 1 to 6 carbon atoms, in particular a tert-butyl group.

18. The process as claimed in claim 16, characterized in that it additionally comprises a step of the reaction of the polymer of the formula (II) which comprises 3-oxopropanoate groups with a diamine in less than the stoichiometric amount.

19. The process as claimed in claim 16, characterized in that no solvents are used in the preparation of the polymer of the formula (I).

20. A process for the preparation of the composition as claimed in claim 1, characterized in that the polymer of the formula (I) is mixed with additional components in the absence of moisture.

21. The use of the composition as claimed in claim 1 as an adhesive, sealing compound, coating or lining.

22. An arrangement, characterized in that it comprises a composition as claimed in claim 1.

23. A solid or article, characterized in that the surface thereof has been brought at least partly into contact with a composition as claimed in claim 1.

24. A method of adhesive bonding, characterized in that it comprises a step of bringing a solid or an article into contact with a composition as claimed in claim 1.

25. A method for sealing, characterized in that it comprises a step of bringing a solid or an article into contact with a composition as claimed in claim 1.

26. A method of coating, characterized in that it comprises a step of bringing a solid or an article into contact with a composition as claimed in claim 1.

27. The method as claimed in claim 24, characterized in that it comprises an additional step of curing in the air.

28. The method as claimed in claim 24, characterized in that it comprises an additional step of bringing into contact with a water-containing component or admixing thereof.
